(19) United States
(12) Patent Application Publication
(10) Pub. No.: US 2022/0090434 A1
(43) Pub. Date: Mar. 24, 2022

(54) SWITCH DEVICE FOR TURNSTILE PASSAGE

(71) Applicant: SHANGHAI HUAMING INTELLIGENT TERMINAL EQUIPMENT CO., LTD., Shanghai (CN)

(72) Inventors: Liang ZHANG, Shanghai (CN); Yi ZENG, Shanghai (CN); Hailin LI, Shanghai (CN); Silong MA, Shanghai (CN); Yong MA, Shanghai (CN)

(21) Appl. No.: 17/278,678

(22) PCT Filed: Apr. 24, 2019
(86) PCT No.: PCT/CN2019/084152

§ 371 Date: Mar. 23, 2021

(30) Foreign Application Priority Data
Oct. 15, 2018 (CN) 201811198665.2
Oct. 15, 2018 (CN) 201821677354.X

(51) Int. Cl. E05F 15/649; E05F 3/00; E06B 11/08; E01F 13/04

(52) U.S. Cl. CPC E05F 15/649; E05F 3/00; E06B 11/085; E01F 13/048; E05Y 2900/40; E05Y 2201/434; E05Y 2201/686; E05Y 2201/684; E05Y 2400/10; E05Y 2201/21

(57) ABSTRACT

The objective of this application is to provide a switch device of a turnstile passage, consisting of a flap, a base, a frame, a guide rail mechanism arranged on the base and movably connected to the flap, a connecting rod swing mechanism 5 arranged on the frame 3, and a driving mechanism 6. One end of the connecting rod swing mechanism is rotationally connected to the flap so that the flap on the guide rail mechanism reciprocates between a closed position and an open position of the turnstile passage when the connecting rod swing mechanism swings; and the other end of the rod connecting rod swing mechanism is rotationally connected to the driving mechanism for driving the connecting rod swing mechanism to swing.

### TECHNICAL FIELD

The present invention relates to a turnstile, and in particular, to a switch device of a turnstile passage.

### BACKGROUND

At present, a barrier of a turnstile passage in the prior art is usually divided into three types: a tripod type, a sliding barrier type, and a swing barrier type.

However, the tripod type in the prior art adopts a rotating manner, so that each inclining bar needs to be rotated 120 degrees each time to allow a pedestrian to pass. Therefore, it is very easy to cause a collision with a pedestrian due to a card not properly swiped. In addition, when a pedestrian takes a luggage and other items to pass or an overweight pedestrian passes, obstruction of the inclining bar causes great inconvenience and unnecessary trouble. However, the sliding barrier type has a complex structure and high cost, and is prone to fail to operate normally due to a circuit failure.

When a barrier of the swing barrier type in the prior art is opened and closed, it does not move in a translational manner but rotates in an arc around a support shaft. Further, because a support shaft or a fulcrum needs to support the weight of a flap, the support shaft requires to have a higher strength, it is necessary to use a higher-power motor to drive or to use a low-power motor in combination with of a gearbox to solve problems of a torque and a rotation speed of the support shaft or the fulcrum, as disclosed in patent publication document 201320428775.X, a transmission structure is complicated with high control accuracy requirements and high costs.

### SUMMARY

In view of the forgoing-mentioned shortcomings or deficiencies of the prior art, the technical problem to be solved by the present invention is to provide a switch device of a turnstile passage, which simplifies a transmission structure and satisfies the use requirements of opening and closing control of a flap.

In order to solve the forgoing technical problems, the present invention provides a switch device of a turnstile passage, including a flap, a base, a frame,

a guide rail mechanism arranged on the base and movably connected to the flap;

a connecting rod swing mechanism arranged on the frame, where one end of the connecting rod swing mechanism is rotationally connected to the flap so that the flap on the guide rail mechanism reciprocates between a closed position and an open position of the turnstile passage when the connecting rod swing mechanism swings; and

a driving mechanism rotationally connected to the other end of the connecting rod swing mechanism, and configured to drive the connecting rod swing mechanism to swing.

Compared with the prior art, the switch device of the turnstile passage of the present invention uses a combination of the driving mechanism and the connecting rod swing mechanism to indirectly drive movement of the flap. In addition, by means of movable connection between the flap and the guide rail mechanism and support by the guide rail mechanism arranged on the base, the flap can move stably along the guide rail mechanism during a swinging process of the connecting rod swing mechanism, and then realize opening and closing of the turnstile passage. Therefore, compared with the prior art, this application eliminates the need to turn the flap to close or open the turnstile passage, and can meet requirements of opening and closing control of the flap without adopting a support shaft and a gearbox, which simplifies a transmission structure. In addition, because the connecting rod swing mechanism is rotationally connected to the driving mechanism and the flap, this application can reduce a friction generated by a plurality of parts of the switch device during operation, improve a movement accuracy thereof, and ensure a stable operation of the connecting rod swing mechanism, and extend a service life thereof.

Further, preferably, the guide rail mechanism includes a guide rail arranged on the base, and a rolling bearing arranged on the flap and in a rolling connection to the guide rail. Because the rolling bearing is rolled on the guide rail, a friction of the flap in a translation process is reduced, so that the flap can slide stably on a sliding rail, and noise generated during a sliding process is reduced.

Further, preferably, the connecting rod swing mechanism includes at least one swing rod rotationally connected to the frame, one end of the swing rod being rotationally connected to the flap, and the other end thereof being rotationally connected to the driving mechanism. The driving mechanism drives the swing rod to swing to provide a pushing force of the flap. In addition, this structure makes full use of a lever principle, so that the driving mechanism only needs a small thrust to push the swing rod to rotate, thereby indirectly driving the flap to translate on the sliding rail.

Further, preferably, there are at least two swing rods, and the connecting rod swing mechanism further includes a synchronous connecting rod rotationally connected to each swing rod and the driving mechanism. Therefore, one force applied by the driving mechanism is transformed into a plurality of forces through the connecting rod swing mechanism, thereby making the flap more balanced when a force is applied thereto. In addition, each swing rod is driven to be synchronously rotated by means of the synchronous connecting rod, which is beneficial to balanced stress of the flap.

Further, preferably, the swing rod includes a drive swing rod rotationally connected to the synchronous connecting rod, and a driven swing rod connected to the drive swing rod. One end of the driven swing rod is rotationally connected to the frame via a swing rod shaft, and the other end thereof is rotationally connected to the flap via a rotating shaft. Each drive swing rod is rotationally connected to the synchronous connecting rod via a corresponding synchronous shaft, respectively.

Further, preferably, each synchronous shaft is parallel to the swing rod shaft and the rotating shaft. The drive swing rods are parallel to each other; and the driven swing rods are parallel to each other. Therefore, a magnitude and a direction of the transmission force can be changed through mutual interaction and length change between the drive swing rod and the driven swing rod, so that a moving path of the flap meets actual requirements when a swing amplitude of the synchronous connecting rod is relatively small. This is conducive to reducing the length of the synchronous connecting rod and power of a driving motor, which is beneficial to a space layout inside a turnstile.

Further, preferably, an axial direction of the synchronous connecting rod and a sliding direction of the flap on the guide rail mechanism are perpendicular to each other. Shaft centers between the swing rod shafts and shaft centers between the rotating shafts are all located on the same axis parallel to the synchronous connecting rod. Therefore, the connecting rod swing mechanism forms a stable parallelogram structure, which is beneficial to design and control of strokes of the synchronous connecting rod and the flap.

Further, preferably, the drive swing rod and the driven swing rod are perpendicular to each other. Therefore, a rigid connection between the drive swing rod and the driven swing rod is improved, and transmission efficiency is optimized.

Further, preferably, the flap includes a flap body, a bracket, a sliding rail arranged on the bracket, and a slider slidably arranged on the sliding rail for being rotationally connected to the connecting rod swing mechanism. Through relative movement between the slider and the flap body, the flap body restricts upward degree of freedom of the flap body under its own weight, and restricts downward degree of freedom of the flap body under support of the guide rail mechanism. Therefore, when the connecting rod swing mechanism swings, a translational thrust is generated on the flap, and a phenomenon of jamming at one end of a rotatable connection between the connecting rod swing mechanism and the flap is avoided when the flap slides on the guide rail mechanism.

Further, preferably, the sliding rail is a linear sliding rail, and the sliding direction of the slider is perpendicular to a sliding direction of the flap on the guide rail mechanism. Therefore, when the slider is driven by the connecting rod swing mechanism to swing leftwards and rightwards, a relative linear movement is generated between the linear sliding rail and the slider, so that a thrust generated by the connecting rod swing mechanism is transformed to be a translational thrust parallel to a sliding direction of the flap to the maximum extent.

Further, preferably, there are at least two sliders. The connecting rod swing mechanism includes an adjusting rod parallel to an axial direction of the linear sliding rail and connected to each slider for adjusting a distance between the sliders. Therefore, synchronization of each slider is maintained when the slider is moved, while rotation movement of the flap is eliminated to the maximum extent when the flap is moved, thereby avoiding a phenomenon of inclination of the flap due to uneven stress when the flap is moved.

Further, preferably, the driving mechanism includes a revolving arm rotationally connected to the connecting rod swing mechanism at one end thereof, a rotating arm rotationally connected to the revolving arm, and a driving shaft of a driving motor rotationally connected to the rotating arm; where the rotating arm is driven by the driving shaft to perform a circular motion. With this structure, rotation motion of the driving motor is transformed into circular motion of the revolving arm, enabling the rotating arm to swing regularly, so that the flap performs regular translation in conjunction with the guide rail mechanism, which improves control precision.

Further, preferably, the driving mechanism further includes an opening limiter and a closing limiter that are arranged on the frame; where the flap is in an open position when the flap stops rotating because the rotating arm touches the opening limiter. The flap is in a closed position when the flap stops because the rotating arm touches the closing limiter. Therefore, through interaction of the opening limiter and the closing limiter, a swing angle of the rotating arm is limited, thereby limiting a swing amplitude of the swing arm, then controlling a swing amplitude of the connecting rod swing mechanism, and further controlling a movement stroke and a movement range of the flap.

Further, preferably, in order to intelligently control a flap opening speed, a flap closing speed and strength, the driving mechanism further includes a protective cover fixedly connected to the frame, an electromagnetic brake assembly arranged in the protective cover and connected to the driving shaft, and a controller electrically connected to the electromagnetic brake assembly and the driving motor.

Further, preferably, the driving mechanism further includes a resetting mechanism arranged on the frame and connected to the connecting rod swing mechanism. The driving mechanism or the flap and is used for enabling an automatic return of the connecting rod swing mechanism to the open position from the closed position. Therefore, when the turnstile loses power or encounters a power failure, the flap automatically resets to an open state from a closed state to ensure smooth passage of the turnstile passage and avoid a crowded and blocked passenger flow.

Further, preferably, the resetting mechanism includes a first tension spring seat arranged on the revolving arm of the driving mechanism, a second tension spring seat arranged on the frame, and a tension spring both ends of which are connected to the first tension spring seat and the second tension spring seat, respectively; where the tension spring is in a stretched state when the flap is in the closed position. Through an elastic return action of the tension spring, the synchronous connecting rod can be pulled so that the connecting rod swing mechanism instantly returns to an initial position, that is, the flap quickly moves to the open position, which saves power and improves resetting efficiency.

### BRIEF DESCRIPTION OF THE DIAGRAMS

By reading the detailed description of non-limiting embodiments with reference to the following drawings, other features, objectives and advantages of the present application become more apparent:

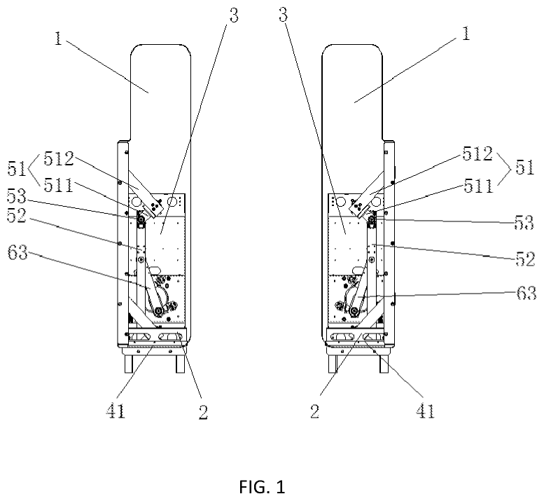

FIG. 1: a schematic structural diagram of a switch device when a flap is opened in a first embodiment of the present invention;

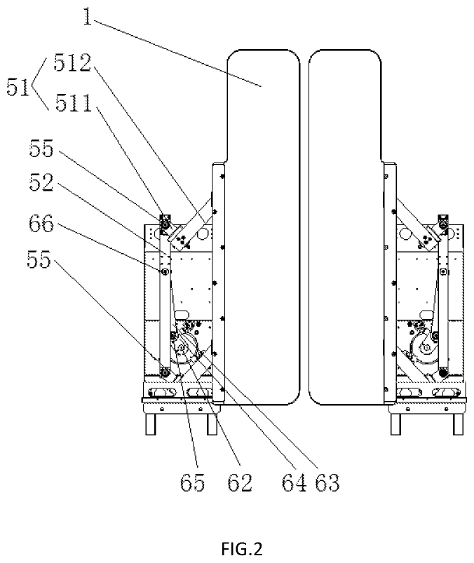

FIG. 2: a schematic structural diagram of a switch device when a flap is closed in a first embodiment of the present invention;

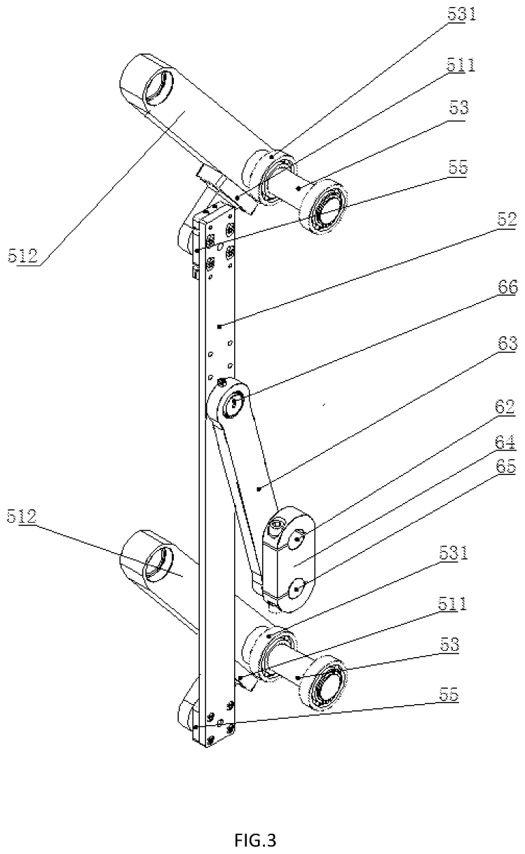

FIG. 3: a schematic structural diagram of a connecting rod swing mechanism in a first embodiment of the present invention;

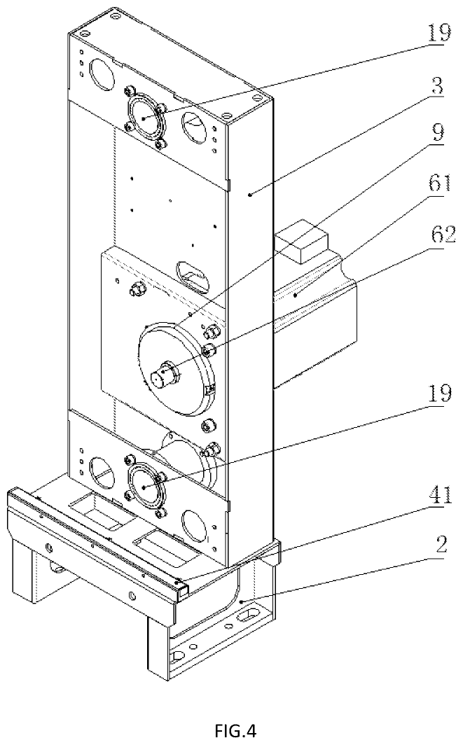

FIG. 4: a schematic structural diagram of a frame and a base in a first embodiment of the present invention;

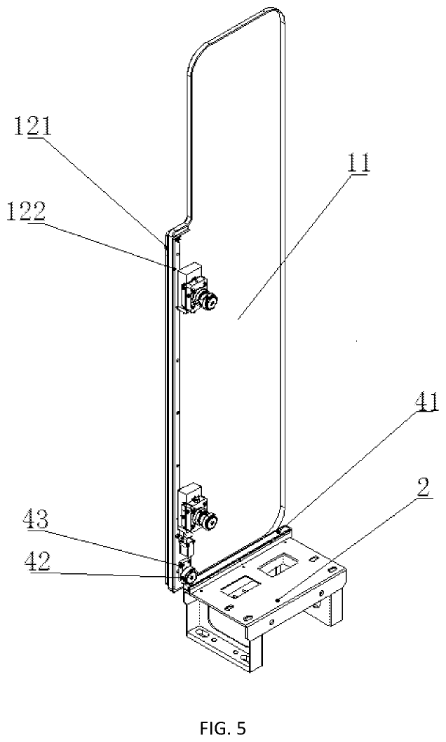

FIG. 5: a schematic structural diagram of a flap in a first embodiment of the present invention;

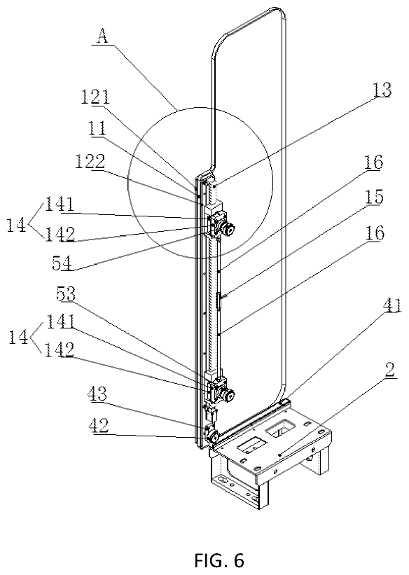

FIG. 6: a schematic structural diagram of a flap in a second embodiment of the present invention;

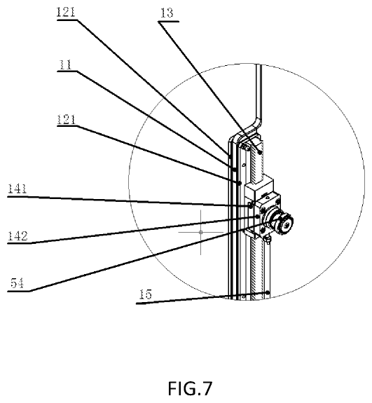

FIG. 7: an enlarged schematic diagram of a part marked with A in FIG. 6;

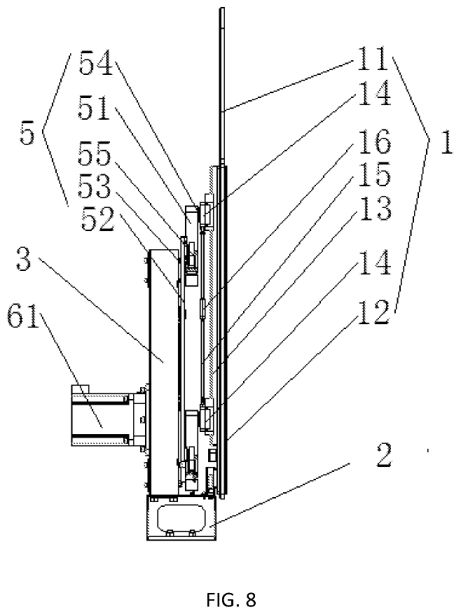

FIG. 8: a side view of a switch device in a third embodiment of the present invention;

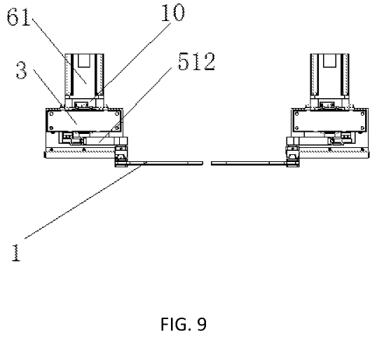

FIG. 9: a top view of a switch device in a third embodiment of the present invention;

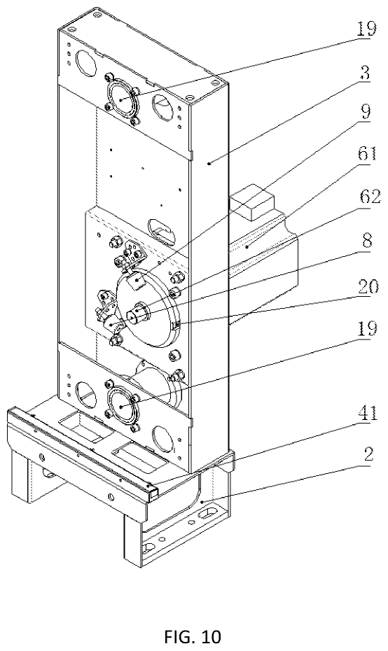

FIG. 10: a schematic structural diagram of a frame and a base in a third embodiment of the present invention;

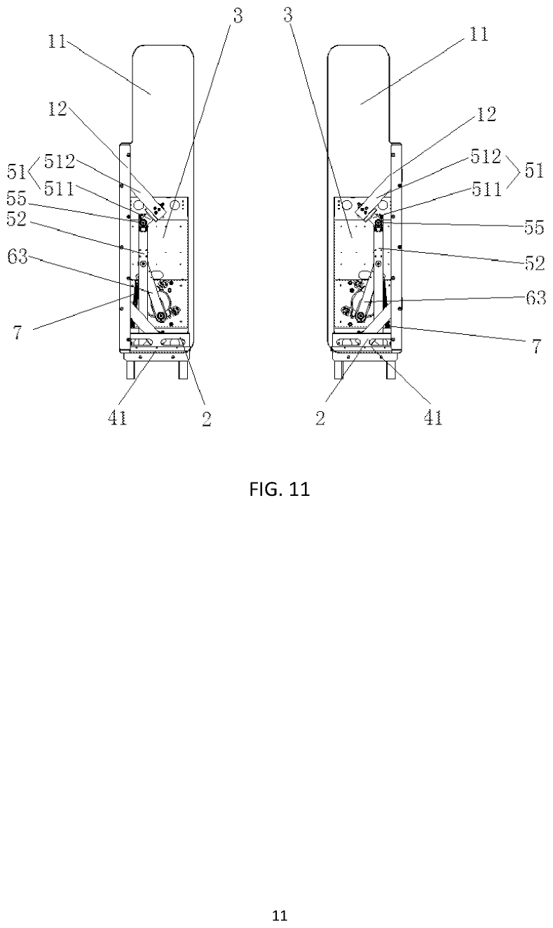

FIG. 11: a schematic structural diagram of a switch device when a flap is opened in a fourth embodiment of the present invention;

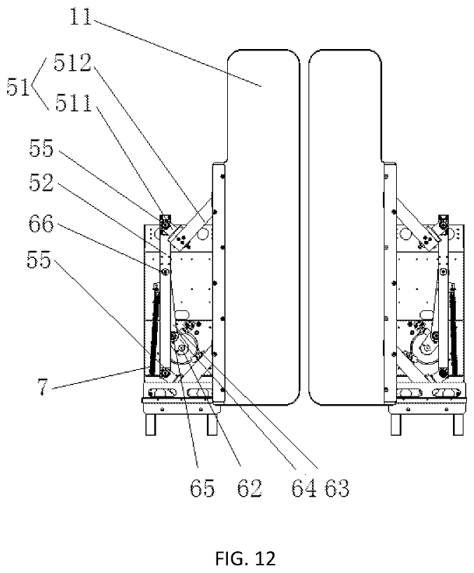

FIG. 12: a schematic structural diagram of a switch device when a flap is closed in a fourth embodiment of the present invention;

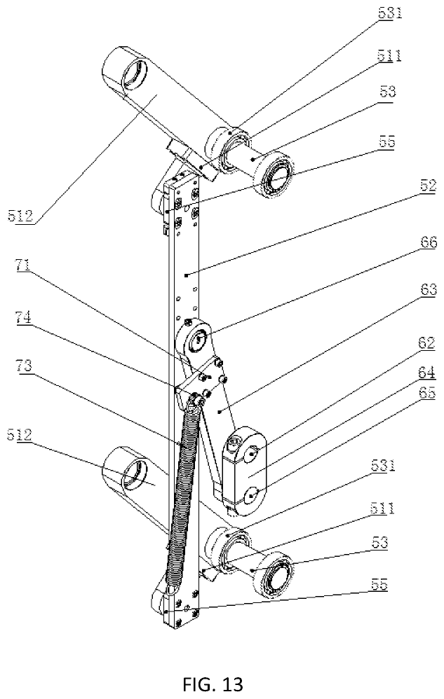

FIG. 13: a schematic structural diagram of a connecting rod swing mechanism in a fourth embodiment of the present invention;

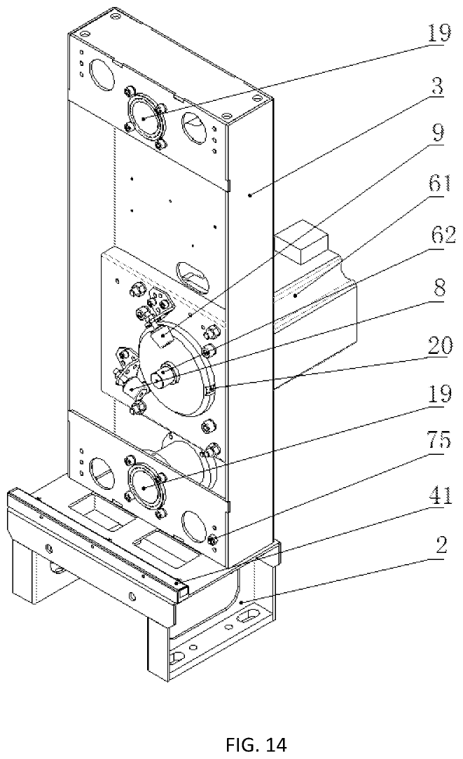

FIG. 14: a schematic structural diagram of a frame and a base in a fourth embodiment of the present invention;

Reference signs: Flap—1; Base—2; Frame—3; Guide Rail Mechanism—4; Connecting Rod Swing Mechanism—5; Driving Mechanism—6; Resetting mechanism—7; Opening Limiter—8; Closing limiter—9; Protective Cover—10; Flap body—11; Bracket—12; Flap panel Fixing Frame 121; Sliding Rail Fixing Seat 122; Sliding Rail—13; Slider—14; Adjusting Rod—15; Slider Distance Adjustment Cap—16; Swing Rod Shaft Hole—19; Electromagnetic Brake—20; Guide Rail—41; Rolling Bearing—42; Support Seat—43; Swing Rod—51; Synchronous Connecting Rod—52; Swing Rod Shaft—53; Rotating Shaft—54; Synchronous Shaft—55; Driving Motor—61; Driving Shaft—62; Revolving Arm—63; Rotating Arm—64; Connecting Shaft—65; First Tension Spring Seat—71; Second Tension Spring Seat—72; Tension Spring—73; Fixing Bolt—74; Fixing Bolt—75; Slider Body—141; Slider Fixing Seat—142; Drive Swing Rod—511; Driven Swing Rod—512; Bearing Sleeve—531.

### DETAILED DESCRIPTION OF THE INVENTION

In the following, the concept, specific structures and technical effects of the present invention are further described with reference to the drawings so that the person skilled can fully understand objectives, features and effects of the present invention.

### Embodiment 1

As shown in FIGS. 1 and 2, Embodiment 1 of the present invention provides a switch device of a turnstile passage, consisting of a flap 1, a base 2, a frame 3, a guide rail mechanism 4 arranged on the base 2 and movably connected to the flap, a connecting rod swing mechanism 5 arranged on the frame 3, and a driving mechanism 6.

One end of the connecting rod swing mechanism 5 is rotationally connected to the flap 1 so that the flap 1 reciprocates between a closed position and an open position of the turnstile passage on the guide rail mechanism 4 when the connecting rod swing mechanism 5 swings. Normally, the base is arranged inside a turnstile. As shown in FIG. 1, when the flap 1 moves to the open position, the most part of the flap is located outside the turnstile. As shown in FIG. 2, when the flap 1 moves to the closed position, the flap 1 is for the most part or completely inside the turnstile.

The driving mechanism 6 is rotationally connected to the other end of the connecting rod swing mechanism 5 for driving the connecting rod swing mechanism 5 to swing.

It can be seen from the forgoing content that the switch device of the turnstile passage adopts a combination of the driving mechanism 6 and the connecting rod swing mechanism 5 to indirectly drive the flap 1 to move. In addition, by means of movable connection between the flap 1 and the guide rail mechanism 4 and support by the guide rail mechanism arranged on the base, the flap 1 can move stably along the guide rail mechanism 4 during a swinging process of the connecting rod swing mechanism 5, thereby realizing opening and closing of the turnstile passage. Therefore, compared with the prior art, this application eliminates the need to turn the flap 1 to close or open the turnstile passage, and can meet use requirements of opening and closing control of the flap without using structures such as a support shaft and a gearbox to drive the flap 1, which simplifies a transmission structure. In addition, because the connecting rod swing mechanism 5 is rotationally connected to the driving mechanism 6 and the flap 1, a friction generated by various parts of the switch device during operation can be reduced, and movement accuracy can be improved; further, stable operation of the connecting rod swing mechanism 5 can be ensured, which extends a service life thereof.

Specifically, as shown in FIG. 1, the guide rail mechanism 4 in this embodiment mainly consists of a guide rail 41 arranged on the base 2 and a rolling bearing 42 arranged on the flap 1 and in rolling connection with the guide rail 41. Therefore, the rolling bearing 42 rolls on the guide rail 41, which can reduce a friction of the flap 1 during a translation process of the flap 1 so that the flap 1 can move stably on the guide rail 41, thereby reducing noise generated during movement. As shown in FIG. 5, the rolling bearing 42 in this embodiment is fixed on the flap 1 via a support seat 43, and the other end is supported by the guide rail 41. Therefore, the rolling bearing is resistant to bending and deformation during use, so there is no need to use a material with high specifications, which reduces production and manufacturing costs. In addition, the rolling bearing 42 in this embodiment can be a sliding bearing sleeved on the support base 43 or a pulley arranged on the support base 43, which is not specifically limited and described in this embodiment.

In this embodiment, as a preference, the guide rail 41 is made of a high-hardness polyurethane material. In addition, it should be understood that the guide rail mechanism 4 in this embodiment can also consist of a slider arranged at the bottom of the flap body 11 and slidably fitted with the guide rail 41 to realize movement of the flap 1 on the guide rail 41. Therefore, how the guide rail 41 and the flap 1 form a movable connection is not specifically limited and elaborated in this embodiment. Moreover, as a further preference, a length direction and a horizontal direction of the guide rail 41 in this embodiment are parallel to each other, so that the flap 1 can reciprocate on the guide rail 41 in a horizontal direction.

As shown in FIGS. 2 and 4, the connecting rod swing mechanism 5 in this embodiment can consist of at least one swing rod 51 rotationally connected to the frame 3. One end of the swing rod 51 is rotationally connected to the flap 1, and the other end thereof is rotationally connected to the driving mechanism 6. Therefore, the driving mechanism 6 drives the swing rod 51 to swing to provide a driving force of the flap 1. In addition, this structure makes full use of a lever principle, so that the driving mechanism 6 can push the swing rod 51 to rotate with only a small thrust, thereby indirectly driving the flap 1 to translate on the sliding rail 13.

In details, as a preference, only two swing rods 51 are described as examples in this embodiment, and the connecting rod swing mechanism 5 further includes a synchronous connecting rod 52 rotationally connected to each swing rod 51 and the driving mechanism 6. As a result, one force applied by the driving mechanism 6 is transformed into a plurality of forces through the connecting rod swing mechanism 5 so that the flap 1 is more balanced when a force is applied to the flap 1. In addition, each swing rod 51 is driven to be synchronously rotated by means of the synchronous connecting rod 52, which is beneficial to balanced stress of the flap 1 so that the flap 1 slides stably on the guide rail mechanism 4. It should be understood for the person skilled in the art that a plurality of swing rods 51 in this embodiment can also be designed according to an actual situation, so as to realize transformation from one force to a plurality of forces, which is beneficial to balanced stress of the flap. This is not elaborated herein.

Further, as a preference, as shown in FIGS. 2 and 3, the swing rod 51 in this embodiment mainly consists of a drive swing rod 511 rotationally connected to the synchronous connecting rod 52 and a driven swing rod 512 connected to the drive swing rod 511. One end of the driven swing rod 512 is rotationally connected to the frame 3 through a swing rod shaft 53, and the other end thereof is rotationally connected to the flap 1 through a rotating shaft (not shown in the drawings). Each drive swing rod 511 is rotationally connected to the synchronous connecting rod 52 through the corresponding synchronous shaft 55, respectively. Therefore, a magnitude and a direction of the transmission force can be changed through mutual interaction and length change between the drive swing rod 511 and the driven swing rod 512, so that a moving path of the flap 1 meets actual requirements when a swing amplitude of the synchronous connecting rod 52 is relatively small. This is conducive to reducing the length of the synchronous connecting rod 52 and power of a driving motor 61, which is beneficial to a space layout inside a turnstile.

Further, as preference, as shown in FIG. 3, in this embodiment, each synchronous shaft 55 is parallel to the swing rod shaft 53 and the rotating shaft. The drive swing rods 511 are parallel to each other; and the driven swing rods 512 are parallel to each other. Through this arrangement, rotation of the driven swing rod 512 and the active swing rod 511 can be kept synchronized during a swing process of the synchronous connecting rod 52, so as to avoid a phenomenon of inclination caused by upper and lower uneven forces on the flap 1 during a sliding process of the flap 1.

Further, as a preference, as shown in FIGS. 3 and 4, in this embodiment, an axial direction of the synchronous connecting rod 52 and a sliding direction of the flap 1 on the guide rail mechanism 4 are perpendicular to each other. Shaft centers between the swing rod shafts 53 and shaft centers between the rotating shafts are all located on the same axis parallel to the synchronous connecting rod 52. Therefore, the connecting rod swing mechanism 5 forms a stable parallelogram structure, which is beneficial to design and control of strokes of the synchronous connecting rod 52 and the flap 1.

Further, as a preference, the drive swing rod 511 and the driven swing rod 512 are perpendicular to each other in this embodiment, so as to improve a rigid connection between the drive swing rod 511 and the driven swing rod 512 and optimize transmission efficiency.

In addition, it should be noted that a length of the drive swing rod 511 in this embodiment is less than a length of the driven swing rod 512, and a position where the drive swing rod 511 is rotationally connected to the synchronous connecting rod 52 through the synchronous shaft 55 is lower than a position where the drive swing rod 51 is rotationally connected to the frame 3, which is beneficial to a layout of the connecting rod swing mechanism 5 inside the turnstile.

As shown in FIG. 4, the base in this embodiment is provided with a swing rod shaft hole 19 for inserting one end of the corresponding swing shaft 53 and forming a rotatable connection through a corresponding bearing sleeve 531. One end of the swing shaft 53 is also inserted into a through hole (marked in the drawings) of the driven swing rod 512 to form a rotatable connection through the corresponding bearing sleeve 531. In the same way, two ends of the rotating shaft adopt the corresponding bearing sleeve to form a rotatable connection with the flap 1 and the driven swing rod 512, respectively. Here, it should be noted that the swing rod shaft 53 and the rotating shaft in this embodiment can be rotationally connected through a pivot connection and the like, in addition to through the bearing sleeve. In the same way, the synchronous shaft 55 can also interact with the corresponding bearing sleeve to realize a rotatable connection between the drive swing rod 512 and the synchronous connecting rod 52, and a rotatable connection between the revolving arm 63 and the synchronous connecting rod 52. This embodiment does not specifically limit and describe this herein.

As shown in FIGS. 1 to 3, the forgoing driving mechanism 6 further includes the revolving arm 63 rotationally connected to the connecting rod swing mechanism 5 at one end thereof, a rotating arm 64 rotationally connected to the revolving arm 63 through a connecting shaft 65, and a driving shaft 62 of the driving motor 61a rotationally connected to the rotating arm 64. The rotating arm 64 is driven by the driving shaft 62 to perform a circular motion. With this structure, a rotation motion of the driving motor 61 is transformed into a circular motion of the rotating arm 64, and the rotating arm 63 is facilitated to swing regularly so that the flap 1 is regularly translated under influence the influence of the interaction with the guide rail mechanism 4, which improves control accuracy.

It should be noted that in this embodiment, as a preference, the swing arm 63 and the synchronous connecting rod 52 in this embodiment are hinged by a connection shaft 66. Obviously, the revolving arm 63 in this embodiment can also be directly hinged with the swing rod 51 according to actual needs, without using the synchronous connecting rod 52. Therefore, whether the swing arm 63 is hinged with the synchronous connecting rod 52 or directly connected to the swing rod 51 is not limited and elaborated in details in this embodiment.

In order to briefly explain the working principle of the switch device of this embodiment, the switch device of this embodiment consists of two symmetrically arranged flaps 1, the base 2, the frame 3, the guide rail mechanism 4 arranged on the base 2 and movably connected to the flap 1, the connecting rod swing mechanism 5 arranged on the frame 3, and the driving mechanism 6, where the two bases 2 and the frame 3 are located in a housing (not marked in the drawings) of the turnstile, respectively, and the turnstile passage part is formed between the two housings.

As shown in FIG. 1, the two flaps 1 move towards each other and gradually move closer to each other while sliding from an open position to a closed position along the guide rail 41 in a horizontal direction under a swing action of the corresponding connecting rod swing mechanism 5, so that the turnstile passage is closed when reaching the closed position. As shown in FIG. 2, when the two flaps 1 slide along the guide rail 41 from the closed position to the open position under the swing action of the corresponding connecting rod swing mechanism 5, the two flaps move backwards from each other and gradually separate from each other, thereby achieving opening of the turnstile passage.

### Embodiment 2

Embodiment 2 of the present invention provides a switch device of a turnstile passage. This embodiment is a further improvement of the forgoing Embodiment 1. The improvement lies in: as shown in FIGS. 6 to 7, a flap 1 in this embodiment mainly consists of a flap body 11, a bracket 12, a sliding rail 13 arranged on the bracket 12, and a slider 14 slidably arranged on the sliding rail 13 for being rotationally connected to a connecting rod swing mechanism 5. Through relative movement between the slider 14 and the flap body 11, the flap body 11 restricts upward degree of freedom of the flap body under its own weight, and restricts downward degree of freedom of the flap body under support of a guide rail mechanism 4. Therefore, when the connecting rod swing mechanism 5 swings, a translational thrust is generated on the flap 1, and a phenomenon of jamming at one end of a rotatable connection between the connecting rod swing mechanism 5 and the flap 1 is avoided when the flap 1 moves on the guide rail mechanism 4.

As a preference, as shown in FIG. 5, the sliding rail 13 in this embodiment is a linear sliding rail, and a sliding direction of the slider 14 is perpendicular to a sliding direction of the flap 1 on the guide rail mechanism 4. Therefore, when the slider 14 is driven by the connecting rod swing mechanism 5 to swing leftwards and rightwards, a relative linear movement is generated between the linear sliding rail and the slider 14, so that a thrust generated by the connecting rod swing mechanism 5 is transformed to be a translational thrust parallel to a sliding direction of the flap 1 to the maximum extent.

It should be noted that the sliding rail 13 in this embodiment can also be designed in an arc shape or other regular or irregular shapes according to actual conditions. This embodiment only uses the sliding rail 13 as a linear sliding rail for brief description.

As shown in FIG. 6, there are preferably two sliders 14 in this embodiment, which are rotationally connected to the corresponding swing rod shaft 53 in the connecting rod swing mechanism 5, respectively. It should be understood that other numbers of sliders 14 can also be selected in this embodiment according to actual needs, and no specific limitation and description are made herein.

In addition, the flap 1 in this embodiment further includes an adjusting rod 15 parallel to an axial direction of the linear sliding rail and connected to the sliders 14 for adjusting a distance between the sliders 14 to ensure synchronism of the sliders 14 when the sliders 14 move to the maximum extent, and to avoid a phenomenon that the flap 1 is inclined due to uneven stress during movement while eliminating rotation movement of the flap 1 when the flap 1 moves.

In details, as shown in FIG. 6, the flap 1 further includes a slider distance adjusting cap 16 arranged on the slider 14 for adjusting a length of the adjusting rod 15 to facilitate the user's adjustment and assembly. As a preference, a length of the adjusting rod 15 in this embodiment is equal to a distance between the swing rod shafts 53 of swing rods 51 that are connected correspondingly. In conjunction with the connecting rod swing mechanism 5, a parallelogram structure is formed to ensure that a sliding direction and a sliding distance of each slider 14 are consistent.

In addition, it should be noted that the forgoing adjusting rod 15 can be detachably connected to the slider 14, or can be connected as a whole according to actual needs. In addition, there is one adjusting rod 15 in this embodiment. In actual application, the number of adjusting rods 15 can be correspondingly set to two, three, and so on according to the actual number of the sliders 14. Therefore, this embodiment does not specifically limit and elaborate this.

In addition, more preferably, the forgoing slider 14 is preferably a self-lubricating silent slider, so as to eliminate noise generated when the slider 14 and the sliding rail 13 move, as much as possible. The flap body 11 adopts a tempered glass flap, and the bracket 12 consists of a flap panel fixing frame 121 and a sliding rail fixing seat 122 arranged on the flap panel fixing frame 121.

As shown in FIGS. 6 and 7, the slider 14 in this embodiment consists of a slider body 141 slidably arranged on the sliding rail 13 and a slider fixing seat 142 arranged on the slider body 141 to facilitate installation of the rotating shaft 54.

### Embodiment 3

Embodiment 3 of the present invention provides a switch device of a turnstile passage. This embodiment is a further improvement of any one of the forgoing embodiments. The improvement lies in: as shown in FIGS. 8 to 10, a driving mechanism 6 in this embodiment also includes an opening limiter 8 and a closing limiter 9 that are arranged on a frame 3. A flap 1 is in an open position when a rotating arm 64 touches the opening limiter 8 and stops rotating. The flap 1 is in a closed position when the rotating arm 64 touches the closing limiter 9 and stops rotating. Therefore, through interaction of the opening limiter 8 and the closing limiter 9, a swing angle of the rotating arm is limited, thereby limiting a swing amplitude of a swing arm 63, then controlling a swing amplitude of a connecting rod swing mechanism, and further controlling a movement stroke and a movement range of the flap 1.

In addition, as shown in FIGS. 8 and 9, in order to intelligently control a flap opening speed, a flap closing speed and strength of the flap 1, the driving mechanism 6 further includes a protective cover 10 fixedly connected to the frame 3, an electromagnetic brake 20 assembly arranged in the protective cover 10 and connected to the driving shaft 62, and a controller electrically connected to the electromagnetic brake 20 assembly and a driving motor 61.

As shown in FIGS. 8 and 10, the electromagnetic brake 20 assembly in this embodiment can consist of an electromagnetic brake 20, the protective cover 10, and a brake shaft. The electromagnetic brake 20 is mounted in the protective cover 10. One end of the protective cover 10 is connected and fixed to the driving motor 61, and the other end thereof is connected and fixed to the frame 3. A stator of the electromagnetic brake 20 is fixed in the protective cover 10. The brake shaft is also arranged in the protective cover 10. One end of the brake shaft is fixed on an output shaft of the driving motor 61, and the other end thereof is connected and fixed to a motor output connecting rod. A rotor of the electromagnetic brake 20 is mounted on the brake shaft. A contact surface gap between the stator and the rotor is adjusted according to requirements of a manufacturer. In this case, after the stator of the electromagnetic brake 20 is powered on, the rotor is attracted by the stator to have a certain adsorption force as a whole, and the rotor is forced to stop moving; therefore, the driving mechanism 6 is stopped, that is, the flap 1 is forced to stop moving.

In order to better explain a switching process of the switch device in this embodiment, a working principle is briefly described as follows:

Step 1: after a barrier switch device of the turnstile passage is powered on and started, a control system is first self-checked and initialized;

Step 2: when the driving motor 61 is driven because the controller is triggered and sends a corresponding flap closing instruction, and when the rotating arm follows the driving shaft 62 of the motor to rotate counterclockwise until the rotating arm is blocked by the closing limiter 9, the driving motor 61 stops moving when encountering resistance. At this time, the flap 1 is located in a closed position. When the driving motor 61 is driven because the controller is triggered and sends a corresponding flap opening instruction, and when the rotating arm 64 follows the driving shaft 62 of the motor to rotate clockwise until the rotating arm is blocked by the opening limiter 8, the driving motor 61 stops moving when encountering the resistance. At this time, the flap 1 is located at the open position.

In addition, it should be noted that in this embodiment, when the flap 1 in translational movement is stressed by a forward resistance, this resistance is transmitted by the connecting rod swing mechanism 5 to the driving motor 61, so that the controller sends a control instruction to the electromagnetic brake 20 after receiving a feedback signal on the driving motor 61. Therefore, the stator is powered on so that a magnetic adoption generated by the stator after the rotor is powered on further enables the flap 1 in a translational movement to be braked and stopped temporarily at an original place. Therefore, the flap 1 does not pinch and hit a pedestrian again when encountering the resistance, thereby preventing possibility of hurting the pedestrian.

In addition, when the flap 1 in the closed position is slightly moved under an action of a strong external force, the controller can detect reversal of the driving shaft 62 of the driving motor 61 and send a corresponding signal instruction to the electromagnetic brake 20 so that the rotor and the stator are attracted to prevent the flap 1 from being forcibly opened. In addition, through setting of an adsorption force between the rotor and the stator, the flap 1 can also be forced to open when an externally applied force is greater than a preset opening force, so as to avoid a phenomenon that the turnstile cannot be opened due to a malfunction. In addition, through setting of control program of the controller, a sliding flap 1 can resume control after being forcibly opened, and the flap 1 can be automatically closed again under drive of the driving motor 61.

In addition, it is worth mentioning that as a preference, the opening limiter 8 and the closing limiter 9 in this embodiment can be proximity switches that are communicatively connected to the controller so that after the proximity switches are triggered, the proximity switches send a trigger signal to the controller.

Therefore, the driving motor 61 stops running to realize precise control of a stroke of the flap 1.

### Embodiment 4

Embodiment 4 of the present invention provides a switch device of a turnstile passage. As shown in FIGS. 11 to 13, the switch device mainly consists of a flap 1, a base 2, a frame 3, a base 2, a guide rail mechanism 4 arranged on the base 2 and movably connected to the flap 1, a connecting rod swing mechanism 5 arranged on the frame 3, a driving mechanism 6, and a resetting mechanism 7.

One end of the connecting rod swing mechanism 5 is rotationally connected to the flap 1 so that the flap 1 reciprocates between a closed position and an open position of the turnstile passage on the guide rail mechanism 4 when the connecting rod swing mechanism 5 swings. Normally, the base is arranged inside a turnstile. As shown in FIG. 9, when the flap 1 moves to the open position, the flap is for the most part located outside the turnstile. As shown in FIG. 10, when the flap 1 moves to the closed position, the flap 1 is for the most part or completely inside the turnstile.

The driving mechanism 6 is rotationally connected to the other end of the connecting rod swing mechanism 5 for driving the connecting rod swing mechanism 5 to swing.

The resetting mechanism 7 is arranged on the frame 3 and connected to the driving mechanism 6 so that the connecting rod swing mechanism 5 automatically returns to the open position from the closed position.

It can be seen from the forgoing content that the switch device of the turnstile passage adopts a combination of the driving mechanism 6 and the connecting rod swing mechanism 5 to indirectly drive the flap 1 to move. In addition, by means of movable connection between the flap 1 and the guide rail mechanism 4 and support by the guide rail mechanism 4 arranged on the base 2, the flap 1 can move stably along the guide rail mechanism 4 during a swinging process of the connecting rod swing mechanism 5, thereby realizing opening and closing of the turnstile passage. Therefore, compared with the prior art, this application eliminates the need to turn the flap 1 to close or open the turnstile passage, and can meet use requirements of opening and closing control of the flap without using structures such as a support shaft and a gearbox, which simplifies a transmission structure. In addition, because the connecting rod swing mechanism 5 is rotationally connected to the driving mechanism 6 and the flap 1, a friction generated by various parts of the switch device during operation can be reduced, and movement accuracy can be improved; further, stable operation of the connecting rod swing mechanism 5 can be ensured, which extends a service life thereof.

In addition, through connection between the resetting mechanism 7 and the driving mechanism 6, when the turnstile loses power or encounters a power failure, the flap 1 automatically resets to a open state from a closed state to ensure smooth passage of the turnstile passage and avoid a phenomenon of a crowded passenger flow.

Specifically, the resetting mechanism 7 in this embodiment mainly consists of a first tension spring seat 71 arranged on a rotating arm 64, a second tension spring seat 72 arranged on the frame 3, and a tension spring 73 both ends of which are connected to the first tension spring seat and the second tension spring seat 72, respectively. The tension spring 73 is in a stretched state when the flap 1 is located in the closed position.

It can be seen that when the driving mechanism 6 and an electromagnetic brake assembly have failures such as power failure, a synchronous connecting rod 52 can be pulled through an elastic recovery action of the tension spring 73 so that the connecting rod swing mechanism 5 can instantly return to an initial position, that is, the flap 1 quickly moves to the open position, which saves power and improves resetting efficiency.

In details, as shown in FIGS. 11 to 14, the first tension spring seat 71 in this embodiment is a fixing block arranged on a revolving arm 63. One end of the tension spring 73 is sleeved on a fixing bolt 74 on the fixing block, and the other end thereof is sleeved on a fixing bolt 75 arranged on the base 2.

In addition, it should be understood for the person skilled in the art that the tension spring 73 in the resetting mechanism 7 in this embodiment is used to connect one end of the revolving arm 63, and can also be directly connected to the synchronous connecting rod 52 in the connecting rod swing mechanism 5 and the flap 1 to achieve the forgoing objective. Therefore, this embodiment only takes the tension spring 73 connected to the revolving arm 63 as an example for preferred description.

In addition, as shown in FIG. 14, it should be understood that the guide rail mechanism 4 in this embodiment can be selected to consist of a guide rail 41 arranged on the base 2 and a rolling bearing arranged on the flap 1 and in a rolling connection to the guide rail 41 according to actual needs. Therefore, the rolling bearing 42 rolls on the guide rail 41 so that the flap 1 can move stably on the guide rail 41 and reduce noise generated in a movement process while reducing a friction of the flap 1 during a translation process. The supported rolling bearing 42 in this embodiment is fixed on the flap 1 via a support seat 43, and the other end is supported by the guide rail 41. Therefore, the rolling bearing is resistant to bending and deformation during use, so there is no need to use a material with high specifications, which reduces production and manufacturing costs. In addition, the supported rolling bearing 42 in this embodiment can be a sliding bearing sleeved on the support base 43 or a pulley arranged on the support base 43, which is not specifically limited and described in this embodiment.

In this embodiment, as a preference, the guide rail 41 is made of a high-hardness polyurethane material. In addition, it should be understood that the guide rail mechanism 4 in this embodiment can also consist of a slider arranged at the bottom of the flap body 11 and slidably fitted with the guide rail 41 to realize movement of the flap 1 on the guide rail 41. Therefore, how the guide rail 41 and the flap 1 form a movable connection is not specifically limited and elaborated in this embodiment. Moreover, as a further preference, a length direction and a horizontal direction of the guide rail 41 in this embodiment are parallel to each other, so that the flap 1 can reciprocate on the guide rail 41 in a horizontal direction.

As shown in FIGS. 11 and 14, the connecting rod swing mechanism 5 in this embodiment can consist of at least one swing rod 51 rotationally connected to the frame 3. One end of the swing rod 51 is rotationally connected to the flap 1, and the other end thereof is rotationally connected to the driving mechanism 6. Therefore, the driving mechanism 6 drives the swing rod 51 to swing to provide a driving force of the flap 1. In addition, this structure makes full use of a lever principle, so that the driving mechanism 6 can push the swing rod 51 to rotate with only a small thrust, thereby indirectly driving the flap 1 to translate on the sliding rail 13.

In details, as a preference, only two swing rods 51 in this embodiment are described as examples, and the connecting rod swing mechanism 5 further includes a synchronous connecting rod 52 rotationally connected to each swing rod 51 and the driving mechanism 6. As a result, one force applied by the driving mechanism 6 is transformed into a plurality of forces through the connecting rod swing mechanism 5 so that the flap 1 is more balanced when a force is applied to the flap 1. In addition, each swing rod 51 is driven to be synchronously rotated by means of the synchronous connecting rod 52, which is beneficial to balanced stress of the flap 1 so that the flap 1 slides stably on the guide rail mechanism 4. It should be understood for the person skilled in the art that a plurality of swing rods 51 in this embodiment can also be designed according to an actual situation, so as to realize transformation from one force to a plurality of forces, which is beneficial to balanced stress of the flap. This is not elaborated herein.

Further, as a preference, as shown in FIG. 11, the swing rod 51 in this embodiment mainly consists of an drive swing rod 511 rotationally connected to the synchronous connecting rod 52 and a driven swing rod 512 connected to the drive swing rod 511. One end of the driven swing rod 512 is rotationally connected to the frame 3 through the swing rod shaft 53, and the other end thereof is rotationally connected to the flap 1 through the rotating shaft 54. The drive swing rod 511 is rotationally connected to the synchronous connecting rod 52 through a synchronous shaft 55. Therefore, a magnitude and a direction of the transmission force can be changed through mutual interaction and length change between the drive swing rod 511 and the driven swing rod 512, so that a moving path of the flap 1 meets actual requirements when a swing amplitude of the synchronous connecting rod 52 is relatively small. This is conducive to reducing a length of the synchronous connecting rod 52 and power of a driving motor 61, which is beneficial to a space layout inside a turnstile.

Further, as preference, as shown in FIGS. 11 and 12, in this embodiment, each synchronous shaft 55 is parallel to the swing rod shaft 53 and the rotating shaft. The drive swing rods 511 are parallel to each other; and the driven swing rods 512 are parallel to each other. Through this arrangement, rotation of the driven swing rod 512 and the active swing rod 511 can be kept synchronized during a swing process of the synchronous connecting rod 52, so as to avoid a phenomenon of inclination caused by upper and lower uneven forces on the flap 1 during a movement process of the flap 1.

Further, as a preference, in this embodiment, an axial direction of the synchronous connecting rod 52 and a sliding direction of the flap 1 on the guide rail mechanism 4 are perpendicular to each other. Shaft centers between the swing rod shafts 53 and shaft centers between the rotating shafts are all located on the same axis parallel to the synchronous connecting rod 52. Therefore, the connecting rod swing mechanism 5 forms a stable parallelogram structure, which is beneficial to design and control of strokes of the synchronous connecting rod 52 and the flap 1.

Further, as preference, the drive swing rod 511 and the driven swing rod 512 are perpendicular to each other in this embodiment, so as to improve a rigid connection between the drive swing rod 511 and the driven swing rod 512 and optimize transmission efficiency.

Referring to FIG. 4 in the forgoing embodiment, the base in this embodiment is provided with a swing rod shaft hole 19 for inserting one end of the corresponding swing shaft 53 and forming a rotatable connection through a corresponding bearing sleeve 531. One end of the swing shaft 53 is also inserted into a through hole (marked in the drawings) of the driven swing rod 512 to form a rotatable connection through the corresponding bearing sleeve 531. In the same way, two ends of the rotating shaft adopt the corresponding bearing sleeve to form a rotatable connection with the flap 1 and the driven swing rod 512, respectively. Here, it should be noted that the swing rod shaft 53 and the rotating shaft in this embodiment can be rotationally connected through a pivot connection and the like, in addition to through the bearing sleeve. In the same way, the synchronous shaft 55 can also interact with the corresponding bearing sleeve to realize a rotatable connection between the drive swing rod 512 and the synchronous connecting rod 52, and a rotatable connection between the revolving arm 63 and the synchronous connecting rod 52. This embodiment does not specifically limit and describe this herein.

In addition, it should be noted that a length of the drive swing rod 511 in this embodiment is less than a length of the driven swing rod 512, and a position where the drive swing rod 511 is rotationally connected to the synchronous connecting rod 52 through the synchronous shaft 55 is lower than a position where the drive swing rod 51 is rotationally connected to and hinged with the frame 3, which is beneficial to a layout of the connecting rod swing mechanism 5 inside the turnstile.

In addition, referring to FIGS. 4 to 6 of the forgoing embodiment, it can be seen that the flap 1 in this embodiment can consist of a flap body 11, a bracket 12, a sliding rail arranged on the bracket 12, and the slider 14 slidably arranged on the sliding rail for being rotationally connected to the connecting rod swing mechanism 5. Through relative movement between the slider 14 and the flap body 11, the flap body 11 restricts upward degree of freedom of the flap body under its own weight, and restricts downward degree of freedom of the flap body under support of the guide rail mechanism 4. Therefore, when the connecting rod swing mechanism 5 swings, a translational thrust is generated on the flap 1, and a phenomenon of jamming at one end of a rotatable connection between the connecting rod swing mechanism 5 and the flap 1 is avoided when the flap 1 slides on the guide rail mechanism 4.

As a preference, referring to FIG. 5 of the forgoing embodiment, the sliding rail in this embodiment is a linear sliding rail, and a sliding direction of the slider 14 is perpendicular to a sliding direction of the flap 1 on the guide rail mechanism 4. Therefore, when the slider 14 is driven by the connecting rod swing mechanism 5 to swing leftwards and rightwards, a relative linear movement is generated between the linear sliding rail and the slider 14, so that a thrust generated by the connecting rod swing mechanism 5 is transformed to be a translational thrust parallel to a sliding direction of the flap 1 to the maximum extent.

It should be noted that the sliding rail 13 in this embodiment can also be designed in an arc shape or other regular or irregular shapes according to actual conditions. This embodiment only uses the sliding rail 13 as the linear sliding rail for brief description.

Referring to FIG. 5, there are preferably two sliders 14 in this embodiment, which are rotationally connected to the corresponding swing rod shaft 53 in the connecting rod swing mechanism 5, respectively. It should be understood that other number of sliders 14 in this embodiment can also be selected according to actual needs, and no specific limitation and description are made herein.

In addition, the flap 1 in this embodiment further includes an adjusting rod 15 parallel to an axial direction of the linear sliding rail and connected to the sliders 14 for adjusting a distance between the sliders 14 to ensure synchronism of the sliders 14 when the sliders 14 move to the maximum extent, and to avoid a phenomenon that the flap 1 is inclined due to uneven stress during movement while eliminating rotation movement of the flap 1 when the flap 1 moves.

In details, as shown in FIG. 5, the flap 1 further includes a slider distance adjusting cap 16 arranged on the slider 14 for adjusting a length of the adjusting rod 15 to facilitate the user's adjustment and assembly. As a preference, a length of the adjusting rod 15 in this embodiment is equal to a distance between the swing rod shafts 53 of swing rods 51 that are connected correspondingly. In conjunction with the connecting rod swing mechanism 5, a parallelogram structure is formed to ensure that a sliding direction and a sliding distance of each slider 14 are consistent.

In addition, it should be noted that the forgoing adjusting rod 15 can be detachably connected to the slider 14, or can be connected as a whole according to actual needs. In addition, there is one adjusting rod 15 in this embodiment. In actual application, the number of adjusting rods 15 can be set to corresponding two, three, and so on according to the actual number of the sliders 14. Therefore, this embodiment does not specifically limit and elaborate this.

In addition, more preferably, the forgoing slider 14 is preferably a self-lubricating silent slider, so as to eliminate noise generated when the slider 14 and the sliding rail 13 move as much as possible. The flap body 11 adopts a tempered glass flap, and the bracket 12 consists of a flap panel fixing frame 121 and a sliding rail fixing seat 122 arranged on the flap panel fixing frame 121.

Referring to FIGS. 5 and 6, the slider 14 in this embodiment consists of a slider body 141 slidably arranged on the sliding rail 13 and a slider fixing seat 142 arranged on the slider body 141 to facilitate installation of the rotating shaft 54.

As shown in FIG. 10, the forgoing driving mechanism 6 further includes the revolving arm 63 rotationally connected to the connecting rod swing mechanism 5 at one end thereof, a rotating arm 64 rotationally connected to the revolving arm 63 through a connecting shaft 65, and a driving shaft 62 of the driving motor 61a rotationally connected to the rotating arm 64. The rotating arm 64 is driven by the driving shaft 62 to perform a circular motion. With this structure, a rotation motion of the driving motor 61 is transformed into a circular motion of the rotating arm 64, and the rotating arm 63 is enabled to swing regularly so that the flap 1 is regularly translated under the influence of the interaction with the guide rail mechanism 4, which improves control accuracy.

It should be noted that in this embodiment, as a preference, the swing arm 63 and the synchronous connecting rod 52 in this embodiment are hinged by a connection shaft 66. Obviously, the revolving arm 63 in this embodiment can also be directly hinged with the swing rod 51 according to actual needs, without using the synchronous connecting rod 52. Therefore, whether the swing arm 63 is hinged with the synchronous connecting rod 52 or directly connected to the swing rod 51 is not limited and elaborated in details in this embodiment.

In order to briefly explain a working principle of the switch device of this embodiment, the switch device of this embodiment consists of two symmetrically arranged flaps 1, the base 2, the frame 3, the guide rail mechanism 4 arranged on the base 2 and movably connected to the flap 1, the connecting rod swing mechanism 5 arranged on the frame 3, and the driving mechanism 6, where the two bases 2 and the frame 3 are located in a housing of the turnstile, respectively, and the turnstile passage part is formed between the two housings.

As shown in FIGS. 11 and 12, the two flaps 1 move towards each other and gradually move closer to each other while moving from an open position to a closed position along the guide rail 41 under a swing action of the corresponding connecting rod swing mechanism 5, so that the turnstile passage is closed when reaching the closed position. As shown in FIG. 2, when the two flaps 1 move along the guide rail 41 from the closed position to the open position under the swing action of the corresponding connecting rod swing mechanism 5, the two flaps move backwards from each other and gradually separate from each other, thereby achieving opening of the turnstile passage.

In details, as shown in FIG. 14, the forgoing driving mechanism 6 further includes an opening limiter 8 and a closing limiter 9 that are arranged on the frame 3. The flap 1 is in the open position when the rotating arm 64 touches the opening limiter 8 and stops rotating. The flap 1 is in the closed position when the rotating arm 64 touches the closing limiter 9 and stops rotating. Therefore, through interaction of the opening limiter 8 and the closing limiter 9, a swing angle of the rotating arm is limited, thereby limiting a swing amplitude of a swing arm 63, then controlling a swing amplitude of the connecting rod swing mechanism, and further controlling a movement stroke and a movement range of the flap 1.

In addition, it is understandable that in this embodiment, in order to intelligently control a flap opening speed, a flap closing speed and strength of the flap 1, the driving mechanism 6 further selectively includes a protective cover fixedly connected to the frame 3, an electromagnetic brake assembly arranged in the protective cover and connected to the driving shaft 62, and a controller electrically connected to the electromagnetic brake assembly and the driving motor 61 according to actual needs.

The electromagnetic brake 20 assembly in this embodiment can consist of an electromagnetic brake 20, a protective cover 10, and a brake shaft. The electromagnetic brake 20 is mounted in the protective cover 10. One end of the protective cover 10 is connected and fixed to the driving motor 61, and the other end thereof is connected and fixed to the frame 3. A stator of the electromagnetic brake 20 is fixed in the protective cover 10. The brake shaft is also arranged in the protective cover 10. One end of the brake shaft is fixed on an output shaft of the driving motor 61, and the other end thereof is connected and fixed on a motor output connecting rod. A rotor of the electromagnetic brake 20 is mounted on the brake shaft. A contact surface gap between the stator and the rotor is adjusted according to requirements of a manufacturer. In this case, after the stator of the electromagnetic brake 20 is powered on, the rotor is attracted by the stator to have a certain adsorption force as a whole, and the rotor is forced to stop moving; therefore, the driving mechanism 6 is stopped, that is, the flap 1 is forced to stop moving.

### Embodiment 5

Embodiment 5 of the present invention provides a switch device of a turnstile passage. This embodiment is substantially the same as any one of the forgoing Embodiment 3 to Embodiment 4, and difference therebetween lies in:

In this embodiment, when an opening limiter 8 rotates to an angle corresponding to a flap 1 at an open position, a distance of 1 to 5 mm is retained between the opening limiter 8 and a revolving arm 63. Similarly, when a closing limiter 9 in this embodiment rotates to an angle corresponding to the flap 1 at a closed position, a distance of 1 to 5 mm is retained between the closing limiter 9 and the revolving arm 63. Therefore, with this structure and program design of a controller, it is possible to prevent a phenomenon that the opening limiter 8 and the closing limiter 9 are damaged by frequent collisions.

In addition, it should be noted that the closing limiter 9 and the opening limiter 8 in this embodiment can be arranged as stop blocks or limit switches according to actual needs, and no specific limitation and description are made here.

In addition, in an alternative embodiment of the present application, a resetting mechanism 7 can also be replaced by a structure that realizes the same resetting function, such as rebound of a compression spring, in addition to a tension spring 73, which is not elaborated here.

The forgoing embodiments are only used to illustrate the technical solutions of the present invention without limiting the same in any way, and the present invention is only described in detail with reference to the preferred embodiments. The person skilled in the art should understand that modifications or equivalent replacements can be made to the technical solutions of the present invention without departing from the scope of the technical solutions of the present invention. All these modifications or equivalent replacements shall fall within the scope of the claims of the present invention.

What is claimed is:

1. A switch device of a turnstile passage, comprising a flap, a base, and a frame, and being characterized by further comprising:
a guide rail mechanism arranged on the base and movably connected to the flap;
a connecting rod swing mechanism arranged on the frame, wherein one end of the connecting rod swing mechanism is rotationally connected to the flap so that the flap on the guide rail mechanism reciprocates between a closed position and an open position of the turnstile passage when the connecting rod swing mechanism swings;
a driving mechanism rotationally connected to the other end of the connecting rod swing mechanism, and configured to drive the connecting rod swing mechanism to swing.

2. The switch device of the turnstile passage according to claim 1, characterized in that the guide rail mechanism comprises a guide rail arranged on the base, and a rolling bearing arranged on the flap and in a rolling connection to the guide rail.

3. The switch device of the turnstile passage according to claim 1, characterized in that the connecting rod swing mechanism comprises at least one swing rod rotationally connected to the frame;
wherein one end of the swing rod is rotationally connected to the flap, and the other end thereof is rotationally connected to the driving mechanism.

4. The switch device of the turnstile passage according to claim 3, characterized in that there are at least two swing rods, and the connecting rod swing mechanism further comprises a synchronous connecting rod rotationally connected to each swing rod and the driving mechanism.

5. The switch device of the turnstile passage according to claim 4, characterized in that the swing rod comprises a drive swing rod rotationally connected to the synchronous connecting rod, and a driven swing rod connected to the drive swing rod, one end of the driven swing rod being rotationally connected to the frame via a swing rod shaft, and the other end thereof being rotationally connected to the flap via a rotating shaft, each drive swing rod is rotationally connected to the synchronous connecting rod via a corresponding synchronous shaft, respectively.

6. The switch device of the turnstile passage according to claim 5, characterized in that each synchronous shaft is parallel to the swing rod shaft and the rotating shaft, the drive swing rods are parallel to each other; and the driven swing rods are parallel to each other.

7. The switch device of the turnstile passage according to claim 6, characterized in that an axial direction of the synchronous connecting rod and a sliding direction of the flap on the guide rail mechanism are perpendicular to each other, wherein shaft centers between the swing rod shafts and shaft centers between the rotating shafts are all located on the same axis parallel to the synchronous connecting rod.

8. The switch device for the turnstile passage of claim 5, characterized in that the drive swing rod and the driven swing rod are perpendicular to each other.

9. The switch device for the turnstile passage according to claim 1, characterized in that the flap comprises a flap body, a bracket, a sliding rail arranged on the bracket, and a slider slidably arranged on the sliding rail for rotationally connecting to the connecting rod swing mechanism.

10. The switch device of the turnstile passage according to claim 9, characterized in that the sliding rail is a linear sliding rail, and the sliding direction of the slider is perpendicular to a sliding direction of the flap on the guide rail mechanism.

11. The switch device of the turnstile passage according to claim 10, characterized in that there are at least two sliders, the connecting rod swing mechanism comprises an adjusting rod parallel to an axial direction of the linear sliding rail and connected to each slider for adjusting a distance between the sliders.

12. The switch device of the turnstile passage according to claim 1, characterized in that the driving mechanism comprises a revolving arm rotationally connected to the connecting rod swing mechanism at one end thereof, a rotating arm rotationally connected to the revolving arm, and a driving shaft of a driving motor rotationally connected to the rotating arm; wherein the rotating arm is driven by the driving shaft to perform a circular motion.

13. The switch device of the turnstile passage according to claim 12, characterized in that the driving mechanism further comprises an opening limiter and a closing limiter that are arranged on the frame; wherein the flap is in an open position when the flap stops rotating because the rotating arm touches the opening limiter, the flap is in a closed position when the flap stops because the rotating arm touches the closing limiter.

14. The switch device of the turnstile passage according to claim 12, characterized in that the driving mechanism further comprises a protective cover fixedly connected to the frame, an electromagnetic brake assembly arranged in the protective cover and connected to the driving shaft, and a controller electrically connected to the electromagnetic brake assembly and the driving motor.

15. The switch device of the turnstile passage according to claim 1, characterized in that the driving mechanism further comprises a resetting mechanism arranged on the frame and connected to the connecting rod swing mechanism, the driving mechanism or the flap is used for enabling an automatic return of the connecting rod swing mechanism to the open position from the closed position.

16. The switch device of the turnstile passage according to claim 15, characterized in that the resetting mechanism comprises a first tension spring seat arranged on the revolving arm of the driving mechanism, a second tension spring seat arranged on the frame, and a tension spring both ends of which are connected to the first tension spring seat and the second tension spring seat, respectively; wherein the tension spring is in a stretched state when the flap is in the closed position.
